(19) United States
(12) Patent Application Publication
(10) Pub. No.: US 2022/0055263 A1
(43) Pub. Date: Feb. 24, 2022

(54) Polymeric Membrane Useful As A Commercial Roofing Membrane

(71) Applicant: 3M INNOVATIVE PROPERTIES COMPANY, St. Paul, MN (US)

(72) Inventors: Caitlin E. Meree, St. Paul, MN (US); Jeffrey P. Kalish, St. Paul, MN (US); Joshua M. Fishman, Minneapolis, MN (US); Susannah C. Clear, Hastings, MN (US); John S. Edwards, Hudson, WI (US); Duane D. Fansler, Dresser, WI (US); David S. Hays, Woodbury, MN (US); Anthony F. Schultz, Forest Lake, MN (US); Thomas J. Gilbert, St. Paul, MN (US); Michael Kempf, Neuss (DE); Thomas Apeldorn, Mönchengladbach (DE)

(21) Appl. No.: 17/274,845

(22) PCT Filed: Sep. 13, 2019
(86) PCT No.: PCT/US2019/050992

§ 371 Date: Mar. 10, 2021

Related U.S. Application Data
(60) Provisional application No. 62/783,578, filed on Dec. 21, 2018.
(60) Provisional application No. 62/730,656, filed on Sep. 13, 2018.

(51) Int. Cl. B29C 44/06; B29C 44/04; B29C 44/56; C08J 9/00; C08J 9/10; E04D 5/06; C08J 9/32; C08K 3/013

(52) U.S. Cl. CPC B29C 44/06; C08J 2205/052; B29C 44/56; C08J 9/0066; C08J 9/103; E04D 5/06; C08J 9/32; C08K 3/013; C08J 2201/03; C08J 2203/04; C08J 2205/05; C08J 2353/02; C08J 2323/16; C08K 2201/005; B29C 44/0492

(57) ABSTRACT

The present disclosure provides a polymeric membrane. The polymeric membrane includes a first thermoplastic elastomer layer that comprises a styrenic thermoplastic. The thermoplastic elastomer layer has a foam structure. The polymeric membrane can further include an optional second thermoplastic elastomer layer in contact with the first polyolefin layer.

### BACKGROUND

Commercial roofing membranes are disposed over a roof. In some applications the roof is substantially planar. In order to prevent water from collecting and ultimately penetrating the roof, roofing membranes can include a substantially waterproof material. However, the waterproof material may not be strong enough to withstand repeated strikes by debris or constant exposure to ultraviolet radiation. Weakening of the waterproof material can ultimately lead to the membrane failing to provide adequate waterproofing properties. Water can also penetrate at seams between adjacent roofing membranes. Even if the seam is sealed initially, the seal may ultimately fail, thus compromising the water proofing properties of the membrane. There is therefore a need for improved roofing membranes.

### SUMMARY OF THE DISCLOSURE

The present disclosure provides a polymeric membrane. The polymeric membrane includes a first styrenic thermoplastic elastomer layer. The thermoplastic elastomer layer has a foam structure. The polymeric membrane can further include an optional second thermoplastic elastomer layer in contact with the first thermoplastic elastomer layer.

The present disclosure further provides an assembly. The assembly includes a polymeric membrane. The polymeric membrane includes a first thermoplastic elastomer layer. The thermoplastic elastomer layer includes a filler component that is at least about 30 wt % of the thermoplastic elastomer layer. The polymeric membrane can further include an optional second thermoplastic elastomer layer in contact with the first polyolefin layer. The assembly further includes a substrate. A first major surface of the polymeric membrane is adhered to the substrate.

The present disclosure further provides a roof. The roof includes a polymeric membrane. The polymeric membrane includes a first thermoplastic elastomer layer. The thermoplastic elastomer layer includes a filler component that is at least about 30 wt % of the thermoplastic elastomer layer. The polymeric membrane can further include an optional second thermoplastic elastomer layer in contact with the first thermoplastic elastomer layer.

The present disclosure further provides a method of making a polymeric membrane. The method includes contacting a thermoplastic elastomer with at least one of a foaming agent and a filler component to form a mixture. The method further includes extruding the thermoplastic elastomer mixture to form a thermoplastic elastomer polymeric membrane.

The present disclosure further includes a method of forming an assembly. The assembly includes a polymeric membrane. The polymeric membrane includes a first thermoplastic elastomer layer. The thermoplastic elastomer layer includes a filler component that is at least about 30 wt % of the thermoplastic elastomer layer. The polymeric membrane can further include an optional second thermoplastic elastomer layer in contact with the first thermoplastic elastomer layer. The assembly further includes a substrate. A first major surface of the polymeric membrane is adhered to the substrate. The polymeric membrane is applied to a substrate and heated.

There are various advantages to using the polymeric membranes as disclosed herein, some of which are unexpected. For example, according to various embodiments, the polymeric membranes can include thermoplastic polymers that impart waterproofing properties to the membrane. According to various embodiments, the thermoplastic polymers of adjacent layers of the polymeric membrane are capable of at least partially diffusing into each other to form a monolithic structure via co-extrusion, and this can increase the strength of the polymeric membrane. According to various embodiments, the thermoplastic polymers of adjacent polymeric membranes are capable of at least partially diffusing into each other at a seam; thus, a seal can be created and multiple polymeric membranes can be joined to form one monolithic polymeric membrane, which can improve the waterproofing characteristics and strength of the polymeric membrane. According to various embodiments, the polymeric membrane can include a high loading level of fillers, which can help to improve the strength of the polymeric membrane and help it to withstand damage potentially caused by debris striking the membrane. According to various embodiments, the polymeric membrane can include a plurality of closed or open foam cells. This can increase the resiliency of the membrane and help to adjust the density of the membrane. According to various embodiments, the polymeric membrane can have good elasticity, which can help to decrease stress at seams between adjacent polymeric membranes. According to various embodiments, the polymeric membranes can increase energy efficiency in a building to which they are applied for example by being colored white to help prevent excessive heat absorption. According to various embodiments, the polymeric membrane can be easily installed and cut to any suitable size for the substrate to which it is applied. According to various embodiments, the polymeric membrane can include at least one recyclable material.

### BRIEF DESCRIPTION OF THE FIGURES

The drawings illustrate generally, by way of example, but not by way of limitation, various embodiments discussed in the present document.

FIG. 1 is a schematic sectional view of polymeric membrane 100, in accordance with various embodiments.

FIG. 2 is a schematic view of a commercial roofing assembly, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

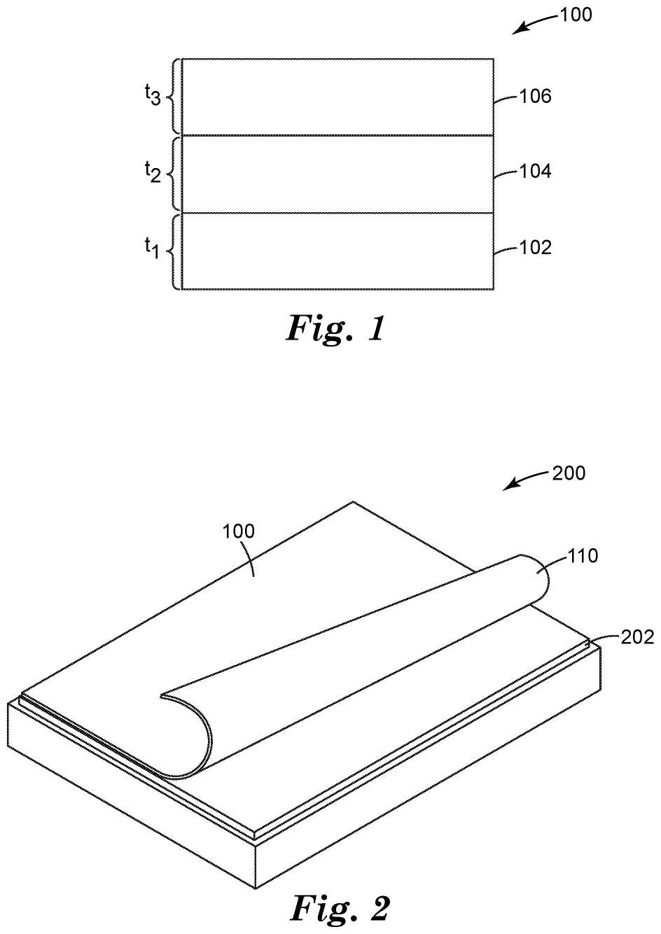

According to various embodiments of the present disclosure a commercial roofing membrane can be generally described as a polymeric membrane. Although the polymeric membrane is described as used in conjunction with a roof, it is understood that the polymeric membranes described herein can be used in conjunction with any other building component. For example, the polymeric membrane can be incorporated into any wall of a building or into the floor of a building. In some embodiments it is possible for the polymeric membrane to be a component of a geomembrane. FIG. 1 is a schematic sectional view of polymeric membrane 100. As shown in FIG. 1, polymeric membrane 100 includes first thermoplastic elastomer layer 102, second thermoplastic elastomer layer 104, and third thermoplastic elastomer layer 106. Although FIG. 1 shows polymeric membrane 100 as including three thermoplastic elastomer layers, it is possible for polymeric membrane 100 to have as few as one thermoplastic elastomer layer, or any plural number of thermoplastic elastomer layers.

As shown, each of layers 102, 104, and 106 are substantially planar. A thickness t₁, t₂, or t₃, of any one of layers 102, 104, and 106 can independently be in a range of from about 3 mils to about 200 mils, about 15 mils, to about 160 mils, or less than, equal to, or greater than about 3 mils, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or about 300 mils. In some embodiments of polymeric membrane 100, a thickness (t₂) of second layer 104 can be larger than a thickness (t₁ and t₃) of any one of layers 102 and 106. In other embodiments, each of first layer 102 and third layer 106 can have a thickness that is greater than second layer 104.

The composition of any one of layers 102, 104, and 106 can be the same. Alternatively, the composition of layers 102, 104, and 106 can be different. As an example of a suitable composition, any of layers 102, 104, or 106 can include a thermoplastic polymer. In further embodiments, any of layers 102, 104, or 106 can include a thermoset polymer. The thermoplastic polymer can be in a range of from about 40 weight percent (wt %) to about 100 wt % of layers 102, 104, and 106, from about 60 wt % to about 95 wt %, or less than, equal to, or greater than about 40 wt %, 45, 50, 55, 60, 65, 70, 75, 80, 85, 90, 95, or about 100 wt %.

The thermoplastic polymer can be any suitable thermoplastic polymer. Properties that make a particular thermoplastic polymer suitable include the glass transition temperature (Tg) of the thermoplastic polymer. Thermoplastic polymers having a certain glass transition temperature can be desirable in that they can be resistant to softening upon exposure to certain temperatures. However, as discussed further herein, it can be desirable for the thermoplastic polymer to have a glass transition temperature that is low enough to allow the thermoplastic polymer to soften and begin to diffuse into an adjacent layer. In some embodiments, a glass transition temperature of the thermoplastic polymer (or melting temperature of a thermoset polymer) can be in a range of from about −100° C. to about 200° C., about 70° C. to about 150° C., or less than, equal to, or greater than about −100° C., −95, −90, −85, −80, −75, −70, −65, −60, −55, −50, −45, −40, −35, −30, −25, −20, −15, −10, −5, 0, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or about 200° C. Some thermoplastic polymers may include multiple glass transition temperatures.

Another property that can make the thermoplastic polymer suitable for use includes the percent elongation at break in either a crossweb or downweb direction. The percent elongation at break should be high enough to allow the thermoplastic polymer as a whole, and therefore of layers 102, 104, and 106, to be resilient and durable upon exposure to strikes from debris such as hail, tree limbs, or other solid objects impacting layers 102, 104, or 106. In some embodiments, the thermoplastic polymer can have a percent elongation in the downweb direction, crossweb direction, or both in a range of from about 110% to about 1000%, about 286% to about 873%, less than, equal to, or greater than about, 110%, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995, or about 1000%. The amount of force at 100% strain for polymeric membrane 100 can be in a range of from about 20 pounds per square inch (PSI) to about 300 PSI, about 22 PSI to about 250 PSI, or less than, equal to, or greater than about 200 PSI, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or about 300 PSI. In addition to the strength of the thermoplastic polymer, in further embodiments, the thermoplastic polymer can have a minimal propensity for water absorption, or at least the bottom layer should have that characteristic.

Specific examples of suitable thermoplastic polymers for any of layers 102, 104, and 106 include an acrylate, a methacrylate, a poly(methyl methacrylate), a siloxane, a styrenic thermoplastic, a styrene-isoprene block copolymer, a styrene ethylene butylene styrene polymer, a hydrogenated styrene ethylene butylene styrene polymer, a polyamide-imide, a polyethersulphone, a polyetherimide, a polyarylate, a polysulphone, a polypropylene, a plasticized polyvinylchloride, an acrylonitrile butadiene styrene, a polystyrene, a polyetherimide, a metallocene-catalyzed polyethylene, a polyethylene, a polyurethane, a fluoroelastomer, or copolymers thereof. In some embodiments, the siloxane can be a polydiorganosiloxane polyoxamide copolymer. Each of layers 102, 104, and 106 can include one of these thermoplastic polymers or a mixture of the thermoplastic polymers. In some embodiments, any of layers 102, 104, or 106 can be free of polypropylene. In embodiments in which any of layers 102, 140, or 106 include the same thermoplastic polymer, it is possible to have a mixture of those polymers having different weight-average molecular weights.

Suitable styrenic thermoplastics include for instance, styrene-isoprene-styrene copolymers, those comprising comprises ethylene and butadiene blocks such as acrylonitrile-butadiene-styrene copolymers, styrene-butadiene-styrene copolymers, styrene-diene block copolymers, styrene-ethylene/butylene-styrene copolymers, and hydrogenated styrene ethylene butadiene styrene polymers. Example styrenic block copolymers may include linear, radial, star and tapered styrene-isoprene block copolymers such as KRATON D1107P, available from Kraton Polymers (Houston, Tex.), and EUROPRENE SOL TE 9110, available from EniChem Elastomers Americas, Inc. (Houston, Tex.), linear styrene-(ethylene/butylene) block copolymers such as KRATON G1657 available from Kraton Polymers, linear styrene-(ethylene/propylene) block copolymers such as KRATON G1657X available from Kraton Polymers, styrene-isoprene-styrene block copolymers such as KRATON D1119P available from Kraton Polymers, acrylonitrile-butadiene-styrene copolymers such as LUSTRAN ABS 348 available from INEOS (London, UK), linear, radial, and star styrene-butadiene block copolymers such as KRATON D1118X, available from Kraton Polymers, and EUROPRENE SOL TE 6205 available from EniChem Elastomers Americas, Inc., or styrene-ethylene-butylene-styrene copolymers, such as KRATON G1567 M, or styrene-ethylene-propylene copolymer, for example the polymer KRATON G1730 M, each commercially available from Kraton Polymers.

Any of layers 102, 104, or 106, can further include a filler component. The filler component can serve to increase the modulus of any of layers 102, 104, and 106, and therefore strengthen polymeric membrane 100 as a whole, to be resilient and durable upon exposure to strikes from debris. Beyond strengthening, the filler component can serve additional purposes such as imparting flame resistance, or inhibition of damage from exposure to ultraviolet radiation. In some embodiments, the filler component also can act as a nucleating agent which can decrease cost by obviating the need for additional nucleating agents in mixtures for forming polymeric membrane 100. In further embodiments, the filler component can create voids that allow for decreased density in polymeric membrane 100.

The filler component can be in a range of from about 30 wt % to about 80 wt % of any one of layers 102, 104, and 106, about 40 wt % to about 50 wt %, or less than, equal to, or greater than about 30 wt %, 35, 40, 45, 50, 55, 60, 65, 70, 75, or about 80 wt %. Each of layers 102, 104, or 106 can have the same wt % of filler component or the wt % can vary for each of layers 102, 104, or 106. In some embodiments, it may be desirable to have an external layer of polymeric membrane 100 include the highest wt % of filler component. In some embodiments one or more of layers 102, 104, or 106 may be free of a filler component.

The filler component can include any filler or blend of fillers. In some embodiments, the fillers can be incorporated into any component of an assembly that includes the polymeric membrane. The fillers can be any particulate filler or inorganic filler. The fillers can be a crystalline or amorphous material. Examples of suitable filler components include nepheline syenite, calcium carbonate, magnesium hydroxide, talc, alumina, zirconia, boehmite, amorphous silica, kaolinite, calcite, a clay, fly ash, rice husk, or mixtures thereof. In some embodiments, the filler can be a pigment such as TiO₂. In some embodiments, the filler component can be a flame retardant or an intumescent material that swells upon exposure to heat. Examples of flame retardants include, organophosphorous compounds such as organic phosphates (including trialkyl phosphates such as triethyl phosphate, tris(2-chloropropyl)phosphate, and triaryl phosphates such as triphenyl phosphate and diphenyl cresyl phosphate, resorcinol bis-diphenylphosphate, resorcinol diphosphate, and aryl phosphate), phosphites (including trialkyl phosphites, triaryl phosphites, and mixed alkyl-aryl phosphites), phosphonates (including diethyl ethyl phosphonate, dimethyl methyl phosphonate), polyphosphates (including melamine polyphosphate, ammonium polyphosphates), polyphosphites, polyphosphonates, phosphinates (including aluminum tris(diethyl phosphinate); halogenated fire retardants such as chlorendic acid derivatives and chlorinated paraffins; organobromines, such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD); metal hydroxides such as magnesium hydroxide, aluminum hydroxide, cobalt hydroxide, and hydrates of the foregoing metal hydroxide; and combinations thereof. The flame retardant can be a reactive type flame-retardant (including polyols which contain phosphorus groups, 10-(2,5-dihydroxyphenyl)-10H-9-oxa-10-phospha-phenanthrene-10-oxide, phosphorus-containing lactone-modified polyesters, ethylene glycol bis(diphenyl phosphate), neopentylglycol bis(diphenyl phosphate), amine- and hydroxyl-functionalized siloxane oligomers).

The fillers can have any suitable morphology. For example, the fillers can be spherical, elongated (e.g., fiber shaped), or have an irregular shape. A largest dimension of an individual filler (e.g., a largest diameter or a largest longitudinal dimension) can be in a range of from about 0.005 μm, about 0.05 μm or about 0.1 μm to about 500 μm, 300 μm, about 100 μm about 40 μm to about 50 μm, or less than, about 5 μm, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 210, 215, 220, 225, 230, 235, 240, 245, 250, 255, 260, 265, 270, 275, 280, 285, 290, 295, or about 300 μm.

Any of layers 102, 104, and 106 can be foamed. Specifically, any of layers 102, 104, and 106 can include a plurality of closed or open cells. In some embodiments, the open cells can be sealed. Including these cells can help to decrease the density of any of layers 102, 104, and 106, which can help to decrease the overall weight of polymeric membrane 100. A density of polymeric membrane 100 or any individual layer can be in a range of from about 0.3 g/cm³ to about 1.20 g/cm³, about 0.70 g/cm³ to about 1.0 g/cm³, or less than, equal to, or greater than about 0.5 g/cm³, 0.55, 0.60, 0.65, 0.70, 0.75, 0.80, 0.85, 0.90, 0.95, 1.00, 1.05, 1.10, 1.15, or about 1.20 g/cm³.

Additionally, including these cells can help to increase the resiliency of any of layers 102, 104, and 106 upon impact with debris. A largest diameter of an individual cell can be in a range of from about 1 μm to about 1000 μm, about 30 μm to about 1000 μm, about 5 μm to about 50 μm, or less than, equal to, or greater than about 1 μm, 50, 100, 150, 200, 250, 300, 350, 400, 450, 500, 550, 600, 650, 700, 750, 800, 850, 900, 950, or about 1000 μm. The cells can account for any volume percent (vol %) of any of layers 102, 104, or 106. For example, the cells can account for about 0.01 vol % to about 70 vol %, about 15 vol % to about 50 vol %, or less than, equal to, or greater than 0.01 vol %, 0.10, 0.15, 1, 1.5, 2, 5, 10, 15, 20, 25, 30, 35, 40, 45, 50, 55, 60, 65, or about 70 vol %. In some embodiments, it may be desirable to have an external layer of polymeric membrane 100 include the highest vol % of cells.

As described further herein, the cells can be formed in any of layers 102, 104, and 106 using a physical blowing agent, a chemical blowing agent, an expandable microsphere, a hollow particle, or mixtures thereof. In embodiments where any of layers 102, 104, or 106 include expandable microspheres, the expandable microspheres can be in a range of from about 0.5 wt % to about 20 wt % of the respective layer, about 2 wt % to about 10 wt %, or less than, equal to, or greater than about 0.5 wt %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 wt %. A volume of any individual expandable microsphere in an expanded state can be in a range of from about 10 times to about 80 times larger than a volume of the expandable microsphere in an unexpanded state, about 30 times to about 50 times larger, or less than, equal to, or greater than about 10 times, 15, 20, 25, 30, 35, 40, 45, 50, 55, 60, 65, 70, 75, or about 80 times larger.

The microspheres can include a plurality of microspheres that are chosen from polymer microspheres, glass microspheres, ceramic microspheres, or combinations thereof. Suitable polymer microspheres may include pre-expanded or unexpanded microspheres. Unexpanded organic hollow microsphere fillers are available, for example, from Akzo Nobel under the trade designation EXPANCEL DU or from Matsumoto Yushi-Seiyaku Co under the trade designation F and FN SERIES. The expandable microspheres include a polymer shell encapsulating a gaseous hydrocarbon or a liquid hydrocarbon that boils below the softening point of the polymer shell such as, for example, isobutane or isooctane. The unexpanded microspheres expand when the temperature is raised to effect foaming so that the composition expands and foams during extrusion. The Expancel DU and Mastumoto F and FN Series type unexpanded microspheres are available in different grades which are characterized by different onset temperatures for expansion and final expansion size and density, which can be selected depending on the foaming temperature of the process. The onset temperature can be in a range of from about 70° C. to 260° C.

Unexpanded microspheres are sometimes also referred to as expandable organic microballoons which are also available, for example, from Lehmann and Voss, Hamburg, Germany under the trade designation MICROPEARL.

Pre-expanded organic hollow microspheres are commercially available, for example, from Lehmann & Voss, Hamburg, Germany under the trade designation DUALITE and from Akzo Nobel under the trade designation EXPANCEL DE or EXPANCEL WE. The pre-expanded organic microspheres may include a polymer shell comprising, for example, an acrylonitrile/acrylate copolymer, a vinylidenechloride/acrylonitrile copolymer, or a mixture thereof. The shell encapsulates a core including, for example, one or more low boiling hydrocarbons.

Polymeric membrane 100 can optionally include reinforcement components such as fibers, a scrim, a fabric, or a nonwoven. A reinforcement component can be located between any of layers 102, 104, and 106 or it can be embedded within any layer or on external surfaces (e.g., a top or bottom surface). When present, a reinforcing component can help to add strength to polymeric membrane 100 or to decrease flexibility in polymeric membrane 100. Reinforcing components can include any suitable reinforcing material. For example, the reinforcing component can include a woven material, a non-woven material, or a mixture thereof. Examples of woven or non-woven materials can include fiber glass, nylon, cotton, cellulosic fiber, wool, rubber, polyester, polypropylene, or mixtures thereof. However, in some embodiments, polymeric membrane 100 can be free of a reinforcement material and still be able to be sufficiently strong and resilient for any application.

As shown in FIG. 1, each of layers 102, 104, and 106 are in direct contact with each other. The materials of each of layers 102, 104, and 106 can be chosen from materials that are capable of at least partially diffusing into each other such that each layer is adhered to one another. This can lead to polymeric membrane 100 being a monolithic structure. As a result, it may not be necessary to include an adhesive or tie layer between any of layers 102, 104, and 106. However, in some embodiments an adhesive or tie layer may be used between any of layers 102, 104, or 106. Even if an adhesive layer is not included between any of layers 102, 104, and 106, an adhesive layer can be disposed on an external surface of polymeric membrane 100. This can be helpful for securing polymeric membrane 100 to a substrate such as a roof. In embodiments in which an adhesive layer is disposed on an external surface of polymeric membrane a release liner may be disposed over the adhesive layer. The release liner can be removed just before polymeric membrane 100 is brought into contact with the substrate. The adhesive layers can be substantially uniform in thickness and coverage. This can help to reduce the risk of creating pockets or voids in which water can collect.

Examples of suitable adhesives include a pressure-sensitive adhesive or a non-pressure sensitive adhesive. For example, the adhesive prepared as described in Example 8 of U.S. Pat. No. RE 36855 is useful. Examples of suitable pressure sensitive adhesives include at least one of a natural rubber-based adhesive, a synthetic rubber based adhesive, a styrene block copolymer-based adhesive, a polyvinyl ether-based adhesive, a poly(methyl acrylate)-based adhesive, a polyolefin-based adhesive, or a silicone-based adhesive. As used herein, an adhesive that is “based” on a particular component means that the adhesive includes at least 50 wt. % of the particular component, based on the total weight of the adhesive. An exemplary adhesive is available under the trade designation “KRATON MD6748” from Kraton, Houston, Tex.

Suitable non-pressure sensitive adhesives include those that “self-bond” or “block” at the temperature at which the polymeric multilayer material is extruded. Examples of suitable non-pressure sensitive adhesives include very low density polyethylene resins such as that available, for example, under the trade designation “INFUSE 9507” from Dow, Midland, Mich., or ethylene copolymer resins with high comonomer content such as a high vinyl acetate-containing ethylene vinyl acetate resin. The adhesive layer can be a hot melt adhesive layer which may not require a release liner.

The adhesive can be applied to polymeric membrane 100 to form an exposed layer of the adhesive. Alternatively, the adhesive can be encapsulated and then applied to polymeric membrane 100. For example, the adhesive can be encapsulated in such a manner to form a plurality of pellets that are applied to polymeric membrane 100. Upon contact with a substrate and the application of a sufficient amount of force, the pellets break thereby exposing the adhesive to the substrate and polymeric membrane 100 such that the two components can be adhered to each other.

In some embodiments, an asphalt material can be used as an adhesive. As understood asphalt (alternatively known as bitumen) is a sticky, black, and highly viscous liquid or semi-solid form of petroleum. It can be found in natural deposits or may be a refined product.

If present, a tie layer can include a compatibilization agent. A compatibilization agent can be passive (e.g., does not react with other components of the layers) or reactive (e.g., reacts with other components of the layers, such as to form crosslinks or grafting). Examples of compatibilization agents can include silane coupling agents, titanate coupling agents, silane adhesion promoters, phenolic adhesion promoters, titanate adhesion promoters, zirconate adhesion promoters, modified polyolefins (e.g., modified to include one or more polar groups, such as a copolymer including polyethylene repeating units and polyolefin repeating units including one or more polar functional groups, such as a copolymer including polyethylene and repeating units formed from maleic anhydride or maleic acid, such as BYNEL 4157, or a polyethylene-co-vinyl acetate such as Polysciences Cat. No. 25359-25), styrene-based polymers (e.g., a polymer including styrene and butadiene repeating units, such as KRAYTON D1102), methacrylate-based polymers, polycaprolactone-based polymers, polycaprolactone polyester/poly(tetramethylene glycol) copolymers, methacrylate-terminated polystyrene, mixture of aliphatic resins of low of medium molecular weight, and tri-block copolymers.

Polymeric membrane 100 can be made according to many suitable methods. An example of a suitable method includes a method based on extrusion. In some embodiments, ifpercentn order to extrude polymeric membrane 100, any of the thermoplastic polymers is combined with at least one of the filler component, a foaming agent, or both. These components can be placed in a feeder or a hopper that feeds into an extruder. Examples of suitable extruders include a single screw extruder, a twin-screw extruder, or a planetary extruder. Suitable twin-screw extruders include a co-rotating-twin-screw extruder or a counter-rotating-twin-screw extruder. As the mixture is passed through the extruder it can be heated to a sufficiently high temperature to soften or melt the components of the mixture. The mixture can ultimately contact a die which can form a layer such as layer 102. An example of a suitable die includes a coat hanger die. Additional layers such as layers 104 and 106 can be extruded in a similar manner. Additionally each of layers 102, 104, and 106 can be coextruded to form polymeric membrane 100 in a single process. In some embodiments, two polymeric membranes can be extruded and then brought into contact with each other to form polymeric membrane 100. This can be useful in some embodiments where extruding polymeric membrane 100, having a desired number of layers would be too thick to accomplish with an extruder.

The extrusion can occur at any suitable temperature. For example, the temperature can be in a range of from about 30° C. to about 220° C., about 70° C. to about 150° C., or less than, equal to, or greater than about 30° C., 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, or about 210° C. The extrusion can occur for any suitable amount of time. For example, the materials can be in the barrel of an extruder for a period of time ranging from about 0.01 hours to about 17 hours, about 1 hour to about 6 hours, or less than, equal to, or greater than about 0.01 hours, 0.05, 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, or 17 hours.

The foaming agent can be added to the mixture just before extrusion. The foaming agent can include an expandable microsphere as described herein. The foaming agent can also include, an exothermic chemical blowing agent, an endothermic chemical blowing agent, a physical blowing agent, or mixtures thereof. Examples of suitable exothermic chemical blowing agents include an azo compound, a diazo compound, a sulfonyl hydrazide, a sulfonyl semicarbazide, a tetrazole, a nitroso compound, an acyl sulfonyl hydrazide, a hydrazine, a thiatriazole, an azides, a sulfonyl azide, an oxalate, a thiatrizene dioxide, isotoic anhydride, ammonium nitrite, or mixtures thereof. Examples of suitable endothermic chemical blowing agents include an inorganic carbonate, a bicarbonate, a nitrate, a borohydride, citric acid, polycarbonic acid, or mixtures thereof.

The physical blowing agent can include a compressed gas, a liquid, a solid, or mixtures thereof. Specific materials that can be suitable physical blowing agents include carbon dioxide, nitrogen, argon, water, butane, 2,2-dimethylpropane, pentane, hexane, heptane, 1-pentene, 1-hexene, 1-heptene, benzene, toluene, a fluorinated hydrocarbon, methanol, ethanol, isopropanol, ethyl ether, isopropyl ketone, or mixtures thereof.

Polymeric membrane 100 can be incorporated into any suitable assembly such as a commercial roofing assembly. FIG. 2 is a schematic view of commercial roofing assembly 200. As shown in FIG. 2, first major surface 110 of polymeric membrane 100 is in contact with substrate 202. Substrate 202 can be a roof, a water moisture barrier, a foam, a metal, asphalt, or a wood (e.g., natural wood, a wood composite, or a laminated wood).

As shown in FIG. 2, polymeric membrane 100 is used as a commercial roofing membrane. The commercial roofing membrane can be substantially planar. This can be the result of the commercial roofing membrane being disposed on a planar roof. In some embodiments an external surface of the commercial roofing membrane is substantially free of any covering. However, in further embodiments the external surface of the commercial roofing membrane can be at least partially covered by a ballast layer (e.g., a rock layer). In further embodiments, the commercial roofing membrane can be covered with a scrim, soil, and grass or a different plant that can be grown in the soil. In further embodiments, the external surface can be at least partially covered with solar panels.

In some embodiments a plurality of polymeric membranes 100 can be placed adjacent to each other in order to cover a large surface area. Adjacent polymeric membranes 100 can be brought into contact with each other at a seam along adjacent minor surfaces. The materials of the adjacent polymeric membrane 100 can be capable of diffusing into each other such that the plurality of layers can form a monolithic membrane. This can help to prevent water from penetrating polymeric membrane 100 at the seams between adjacent membranes.

Diffusion of the adjacent polymeric layers can be accomplished or at least accelerated by heating polymeric membrane 100. For example, polymeric membrane 100 can be heated to a temperature at or greater than a glass transition temperature of the thermoplastic polymer(s) of polymeric membrane 100. For example, polymeric membrane 100 can be heated to a temperature of at least about 70° C. but not above 250° C., or from about 30° C. to about 200° C., about 70° C. to about 150° C., or less than, equal to, or greater than about 30° C., 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or about 200° C. Heat can be affirmatively applied by an installer. Alternatively, exposure to the sun can expose polymeric membrane to temperatures sufficient to begin diffusion. In further embodiments, any layers can be joined by solvent welding.

### EXAMPLES

Unless otherwise noted, all parts, percentages, ratios, etc. in the examples and the rest of the specification are by weight, and all materials used in the examples were used as obtained from the suppliers.

### Materials:

Table 1 provides a list of materials used in the Examples provided herein. Table 2 provides extrusion equipment details.

TABLE 1
Materials

| Designation | Description | Source |
|---|---|---|
| NS | Nepheline Syenite | 3M Company, Little |
| | | Rock, AK |
| Siloxane | Polydiorganosiloxane polyoxamide copolymer prepared according to the | |
| | method of Example 16 in U.S. Pat. No. 7,501,184 to 3M | |
| | Company, St. Paul, MN, the contents of which are hereby | |
| | incorporated by reference | |
| G1657 | Linear triblock copolymer based on styrene and | Kraton Polymers, |
| | ethylene/butylene (SEBS) with a polystyrene | Houston, TX, USA |
| | content of 13% obtained under the trade | |
| | designation KRATON G1657 M | |
| PVC | Polyvinyl chloride polymer | — |
| Foaming agent | Azodicarbamide foaming agent, masterbatch | Techmer PM, Clinton, |
| | pellet obtained under the trade designation | TN, USA |
| | PFM13691 | |
| HIFAX | Reactor TPO (thermoplastic polyolefin) | LyondellBasell, Houston, |
| | | TX |
| VERTEX | Magnesium Hydroxide (MDH) | Huber, Atlanta, GA |
| 60HST MDH | | |
| RP2 | Kaolin Clay | Active Minerals |
| | | International, LLC |
| | | Sparks, MD, USA |
| B878T | UV and Thermal Stabilizer obtained under the | CYTEC INDUSTRIES |
| | trade designation CYASORB CYNERGY | INC., Princeton, NJ, USA |
| | SOLUTIONS ® B878T STABILIZER | |
| Scrim | 9 × 9 1000 denier polyester | Milliken Company, |
| | | Spartenburg, SC, USA |

TABLE 2
Extrusion Equipment

| Equipment | Description and Source |
|---|---|
| 25 mm twin-screw | Twin-screw extruder, type ZSK-25 manufactured by Krupp Werner & |
| extruder (TSE) | Pfleiderer, Ramsey, NJ, USA. |
| Two 1.25″ (32 mm) | 1.25″ (32 mm) single screw extruder manufactured by Killion |
| single screw | Extruders Inc., Cedar Grove NJ, USA |
| extruders (SSE) | |
| Three K-Tron feeders | Loss-in-weight solids feeders, model KCL-KT20, manufactured by K- |
| | Tron America, Pitman, NJ, USA |
| Casting station | 3-roll stack casting station, model KXE-512, manufactured by Davis |
| | Standard, Pawcatuck, CT, USA |
| Multi-layer extrusion | 3-layer film extrusion die, 10″ (25.4 cm) wide, manufactured by |
| die | Premiere Dies Corp., Chippewa Falls, WI |
| Heated hoses | Heated hoses manufactured by Diebolt & Co., Springfield, MA, USA. |

### Test Methods

Density: density was calculated by cutting a 1 inch by 1 inch (2.54 cm by 2.54 cm) sample of polymeric membranes prepared as described in the Examples below. Volumes of the samples were calculated (v=lwh, wherein 1 is length of the sample, w is width and h is thickness), followed by weighing the samples to determine their masses and calculating density (d=mass/volume). Three samples were prepared, and the average density of these samples was recorded and reported as density.

Determination of modulus: A dogbone in accordance with ASTM standard D412-16 (“Standard Test Methods for Vulcanized Rubber and Thermoplastic Elastomers—Tension”) was prepared and placed in the grips of a testing machine. Modulus was measured following the procedure outlined in the standard.

Determination of max puncture load: A dogbone in accordance with FTM 101C was prepared and placed in the grips of a testing machine. Maximum puncture load was measured following the procedure described in the standard.

Determination of tear (peak stress, percent strain at break): A dogbone in accordance with ASTM D624 die C was prepared and placed in the grips of a testing machine. Tear strength (peak strength) and percent strain (percent elongation) at break were measured following the procedure described in the standard.

Determination of foam structure: Open or close cell structure was determined through optical microscopy using a Keyance VHX-1000 Digital Microscope, obtained from Keyance Corporation of America, Itasca, Ill.

### Preparations

### Fillers:

Nepheline syenite was obtained from 3M Company. Particle size was determined using a MICROTRAC S3500 Particle Size Analyzer. Samples weighing 1 gram were prepared and placed in the analyzer for particle size feedback information. Kaolin clay was purchased from Active Minerals.

### EXAMPLES

### Examples A-F

Polymeric membranes comprising a foam structure and non-styrenic thermoplastic elastomers were prepared according to the following description. Examples A-D included a thermoplastic non-styrenic elastomer foam core layer and non-styrenic outerlayers prepared by feeding the components listed on Table 3, below, and 2 wt. % of azodicarbonamide (AZO) foaming agent (based on the total weight of the composition) into a 25 mm twin-screw extruder (TSE) using three K-tron feeders. To ensure good mixing of the filler into the non-styrenic thermoplastic elastomer, the twin-screw extruder screw speed was set to 150 revolutions per minute (RPM). The outer layers were made with single screw extruders, which were gravity fed with polymer pellets. All extruders were connected to a 3-layer die via heated hoses, with the twin-screw extruder feeding the core (center) slot of the 3-layer die. The 3-layers of polymer melt were joined inside the 3-layer die and the 3-layer molten film was cast onto a cooling roll in the casting station. The resulting 3-layer non-styrenic polymeric membrane was wound into a roll. Cooling of the casting roll was achieved by plumbing city water through a chrome finished steel roll. The AZO foaming agent was activated in the die which was heated above 200° C.

The extruded thermoplastic elastomer foam core layers had a thickness of about 40 mils (1016 microns). In Examples A-C and F, varied amounts of filler were additionally provided into the extruder, resulting in filled thermoplastic elastomer foam core layers. Filler amounts shown in Table 3, below, are weight percent based on the total weight of the composition.

In Examples D and E, a single thermoplastic elastomer foam core layer was produced by turning off the outer layer extruders.

Compositions of Examples A-F are shown in Table 3, below.

TABLE 3

| | | | Filler | | | | |
|---|---|---|---|---|---|---|---|
| | | | | Amount | Size | | Density |
| Example | Type | Layers | Type | (wt. %) | (microns) | Polymer | (g/cm³) |
| Example A | Foam | 3 | NS | 30 | 50 | Siloxane | 0.86 |
| Example B | Foam | 3 | NS | 30 | 5 | Siloxane | 0.74 |
| Example C | Foam | 3 | NS | 60 | 5 | Siloxane | 0.85 |
| Example D | Foam | 3 | None | N/A | N/A | Siloxane | 0.68 |
| Example E | Foam | 1 | None | N/A | N/A | Siloxane | 0.73 |
| Example F | Foam | 1 | MDH | 30 | 1.8 | TPO | 0.55 |

### Example 1-13

Polymeric membranes comprising a foam structure and including styrenic thermoplastic elastomers were prepared as generally described in Examples A-F except that a linear triblock copolymer based on styrene and ethylene/butylene (SEBS, G1657) was used. In Example 11, the polymeric membrane was a dual-layer polymeric membrane comprising a SEBS core and TPO outer layer, prepared as described in Example A-F, wherein one of the outer layer extruders was turned off.

Compositions of Examples 1-13 are shown in Table 4 below.

TABLE 4

| | | | | Filler | | | |
|---|---|---|---|---|---|---|---|
| | | | | | Amount | Size | Density |
| Example | Polymer | Type | Layers | Type | (wt. %) | (Microns) | (g/cm³) |
| Example 1 | SEBS | Foam | 1 | None | N/A | N/A | 0.57 |
| Example 2 | SEBS | Foam | 3 | None | N/A | N/A | 0.44 |
| Example 3 | SEBS | Foam | 3 | NS | 30 | 5 | 1.02 |
| Example 4 | SEBS | Foam | 1 | NS | 30 | 50 | 0.83 |
| Example 5 | SEBS | Foam | 1 | NS | 30 | 5 | 0.71 |
| Example 6 | SEBS | Foam | 3 | NS | 30 | 50 | 0.51 |
| Example 7 | SEBS | Foam | 3 | NS | 60 | 50 | 0.74 |
| Example 8 | SEBS | Foam | 3 | NS | 60 | 5 | 0.50 |
| Example 9 | SEBS | Foam | 1 | NS | 60 | 5 | 1.00 |
| Example 10 | SEBS | Foam | 1 | MDH | 30 | 1.8 | 0.55 |
| Example 11 | SEBS (core) | Foam | 2 | MDH | 30 | 1.8 | 7.50 |
| | TPO (outer) | | | None | N/A | N/A | |
| Example 12 | SEBS | Foam | 1 | None | N/A | N/A | 0.46 |
| Example 13 | SEBS | Foam | 1 | NS | 30 | N/M | 0.51 |

### Examples G-S

Polymeric membranes comprising non-styrenic thermoplastic elastomers were prepared as generally described in Examples A-F, except that no foaming agent was used, and as a result, the thermoplastic elastomeric layers were extruded as films.

Examples L-R are single-layer membranes having thickness of about 30 mil. Examples L-O and Q additionally included 5 wt % of TiO₂ and 1 wt % of B878T, based on the total weight of the polymer. Examples L and 0 used a SEBS/TPO blend.

Composition of Examples G-S are shown in Table 5, below. N/M indicates properties that were not measured for the referenced examples.

TABLE 5

| | | | Number | Filler | | | |
|---|---|---|---|---|---|---|---|
| | | | Polymeric | | Amount | Size | Density |
| Example | Polymer | Type | Layers | Type | (wt. %) | (microns) | (g/cm³) |
| Example G | Siloxane | Film | 1 | None | N/A | N/A | 0.99 |
| Example H | Siloxane | Film | 3 | NS | 30 | 50 | 1.06 |
| Example I | Siloxane | Film | 3 | NS | 30 | 5 | 0.96 |
| Example J | Siloxane | Film | 3 | NS | 60 | 50 | 1.15 |
| Example K | Siloxane | Film | 3 | NS | 60 | 5 | 1.20 |
| Example L | SEBS/TPO | Film | 1 | RP2 | 20 | 0.36 | N/M |
| Example M | TPO | Film | 1 | RP2 | 20 | 0.36 | N/M |
| Example N | TPO | Film | 1 | MDH | 20 | 1.8 | N/M |
| Example O | SEBS/TPO | Film | 1 | MDH | 20 | 1.8 | N/M |
| Example P | TPO | Film | 1 | None | N/A | N/A | N/M |
| Example Q | TPO | Film | 1 | MDH | 20 | 1.8 | N/M |
| Example R | PVC | Film | 1 | None | N/A | N/A | N/M |
| Example S | TPO (core) | Film + | | MDH | 20 | 1.8 | N/M |
| | TPO (outer) | Scrim | 2 | MDH | 20 | 1.8 | N/M |

### Examples 14-35

Polymeric membranes including styrenic thermoplastic elastomers were prepared as generally described in Examples G-S, except that a styrenic thermoplastic elastomer (SEBS) was used. Examples 22-26 are single-layer membranes having thickness of about 30 mil. Examples 22-23 and 25-26 additionally included 5 wt % of TiO2 and 1 wt % of B878T, based on the total weight of the polymer.

Examples 25-29 each comprised a styrenic thermoplastic elastomer core layer, an outer thermoplastic elastomer layer, and a scrim disposed between the core layer and the outer layer. In Examples 25, 27 and 28, the outer layers included styrenic thermoplastic elastomers. In Example 26 and 29, the outer layers included non-styrenic thermoplastic elastomers.

Polymeric membranes of Examples 30-35 were about 60 mil thick.

Composition of Examples 14-35 are shown in Table 6 below.

TABLE 6

| | | | Number | Filler | | | |
|---|---|---|---|---|---|---|---|
| | Polymer | | Polymeric | | Amount | Size | Density |
| Examples | (s) | Type | Layers | Type | (wt. %) | (microns) | (g/cm³) |
| Example 14 | SEBS | Film | 1 | None | N/A | N/A | 0.88 |
| Example 15 | SEBS | Film | 1 | NS | 30 | 5 | 1.02 |
| Example 16 | SEBS | Film | 1 | NS | 30 | 50 | 0.97 |
| Example 17 | SEBS | Film | 3 | NS | 30 | 50 | 0.93 |
| Example 18 | SEBS | Film | 3 | NS | 30 | 5 | 0.93 |
| Example 19 | SEBS | Film | 3 | NS | 60 | 50 | 1.05 |
| Example 20 | SEBS | Film | 1 | NS | 60 | 50 | 1.01 |
| Example 21 | SEBS | Film | 1 | NS | 60 | 5 | 1.13 |
| Example 22 | SEBS | Film | 1 | RP2 | 20 | 0.36 | N/M |
| Example 23 | SEBS | Film | 1 | MDH | 20 | 1.8 | N/M |
| Example 24 | SEBS | Film | 1 | None | N/A | N/A | N/M |
| Example 25 | SEBS (core) | Film + Scrim | 2 | RP2 | 20 | 0.36 | N/M |
| | SEBS (outer) | | | RP2 | 20 | 0.36 | N/M |
| Example 26 | SEBS (core) | Film + Scrim | 2 | RP2 (core) | 20 | 0.36 | N/M |
| | TPO (outer) | | | MDH (outer) | 20 | 1.8 | |
| Example 27 | SEBS (core) | Film + Scrim | 2 | None | N/A | N/A | N/M |
| | SEBS (outer) | | | None | N/A | N/A | |
| Example 28 | SEBS (core) | Film + Scrim | 2 | RP2 | 40 | 0.36 | N/M |
| | SEBS (outer) | | | RP2 | 40 | 0.36 | |
| Example 29 | SEBS (core) | Film + Scrim | 2 | RP2 | 40 | 0.36 | N/M |
| | TPO (outer) | | | MDH | 40 | 1.8 | |
| Example 30 | SEBS | Film | 1 | NS | 20 | N/M | N/M |
| Example 31 | SEBS | Film | 1 | NS | 40 | N/M | N/M |
| Example 32 | SEBS | Film | 1 | NS | 60 | N/M | N/M |
| Example 33 | SEBS | Film | 1 | RP2 | 20 | 0.36 | N/M |
| Example 34 | SEBS | Film | 1 | RP2 | 40 | 0.36 | N/M |
| Example 35 | SEBS | Film | 1 | None | N/A | N/A | N/M |

Polymeric membranes prepared as described above were evaluated for mechanical properties. Modulus, density, maximum puncture load, peak stress and foam structure were measured using the procedures described above. Results are reported below.

TABLE 7

| | Percent Strain at Break (%) | Peak Stress (lbf/in²) |
|---|---|---|
| Example A | 295 | 120.1 |
| Example B | 272.3 | 121.1 |
| Example C | 152 | 137.5 |
| Example D | N/M | N/M |
| Example E | 208 | 64.7 |
| Example F | 585.4 | 253.2 |
| Example G | 341.1 | 201.4 |
| Example H | 315.7 | 190.3 |
| Example I | 100.3 | 132 |
| Example J | 144.5 | 166.2 |
| Example 1 | 499.6 | 413 |
| Example 2 | 413.4 | 365.3 |
| Example 3 | N/M | N/M |
| Example 4 | 577.2 | 544.3 |
| Example 5 | 512.5 | 444.6 |
| Example 6 | 479.9 | 545.9 |
| Example 7 | 244.3 | 266.4 |
| Example 8 | 211.7 | 66.2 |
| Example 9 | 418.2 | 520.3 |
| Example 14 | 1895.5 | 766 |
| Example 15 | 1359.1 | 697.9 |
| Example 16 | 1325.4 | 727.5 |
| Example 17 | N/M | N/M |
| Example 18 | N/M | N/M |
| Example 19 | N/M | N/M |
| Example 20 | 296.5 | 300 |
| Example 21 | 454.5 | 205.6 |
| Example 30 | N/M | 154.8 |
| Example 31 | N/M | 160.2 |
| Example 32 | N/M | 157.5 |
| Example 33 | N/M | 463.6 |
| Example 34 | N/M | 612.7 |
| Example 35 | N/M | 305.1 |

TABLE 8

| Examples | Modulus (lbf/in²) | Max Puncture Load (lbf) |
|---|---|---|
| Example 22 | 540 | N/M |
| Example 23 | 443 | N/M |
| Example 24 | N/M | N/M |
| Example 25 | N/M | 390 |
| Example 26 | N/M | 350 |
| Example 27 | 11200 | N/M |
| Example 28 | 16800 | N/M |
| Example 29 | 19600 | N/M |
| Example L | 1716 | N/M |
| Example M | 13525 | N/M |
| Example N | 11655 | N/M |
| Example O | 1260 | N/M |
| Example P | N/M | 245 |
| Example Q | N/M | 260 |
| Example R | N/M | 220 |
| Example S | 30600 | N/M |

TABLE 9

| Examples | Modulus (lbf/in²) | Foam structure |
|---|---|---|
| Example F | 170 | Open |
| Example 10 | 3500 | Mostly closed cells |
| Example 11 | 750 | Mostly closed cells |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### ADDITIONAL EMBODIMENTS

The following exemplary embodiments are provided, the numbering of which is not to be construed as designating levels of importance:

Embodiment 1 provides a polymeric membrane comprising:

a first thermoplastic elastomer layer, comprising a filler component that is at least about 30 wt % of the thermoplastic elastomer layer.

an optional second thermoplastic elastomer layer in contact with the first polyolefin layer.

Embodiment 2 provides the polymeric membrane of Embodiment 1, wherein at least one of the first and the second thermoplastic elastomer independently comprises a thermoplastic polymer having a glass transition temperature in a range of from about −100° C. to about 200° C.

Embodiment 3 provides the polymeric membrane of any one of Embodiments 1 or 2, wherein at least one of the first and the second thermoplastic elastomer independently comprises a thermoplastic polymer having a glass transition temperature in a range of from about 70° C. to about 150° C.

Embodiment 4 provides the polymeric membrane of any one of Embodiments 1-3, wherein at least one of the first and the second thermoplastic elastomer layers independently comprises a thermoplastic polymer having a percent elongation at break of at least 110%.

Embodiment 5 provides the polymeric membrane of any one of Embodiments 1-4, wherein at least one of the first and the second thermoplastic elastomer layers independently comprises a thermoplastic polymer having a percent elongation at break of at least 130%.

Embodiment 6 provides the polymeric membrane of any one of Embodiments 1-5, wherein at least one of the first and the second thermoplastic elastomer layers independently comprises a thermoplastic polymer having a percent elongation at break of at least 150%.

Embodiment 7 provides the polymeric membrane of any one of Embodiments 1-6, wherein at least one of the first and the second thermoplastic elastomer layers independently comprises a thermoplastic polymer having a percent elongation at break of at least 200%.

Embodiment 8 provides the polymeric membrane of any one of Embodiments 1-7, wherein at least one of the first and the second thermoplastic elastomer layers independently comprises a thermoplastic polymer having a percent elongation at break in a range of from about 110% to about 200%.

Embodiment 9 provides the polymeric membrane of any one of Embodiments 1-8, wherein at least one of the first and the second thermoplastic elastomer layers independently comprises a thermoplastic polymer having a percent elongation at break in a range of from about 130% to about 150%.

Embodiment 10 provides the polymeric membrane of any one of Embodiments 1-9, wherein at least one of the first and the second thermoplastic elastomer layers independently comprises an acrylate, a methacrylate, a poly(methyl methacrylate), a siloxane, a styrene-isoprene block copolymer, a styrene ethylene butylene styrene polymer, a hydrogenated styrene ethylene butylene styrene polymer, a polyamide-imide, a polyethersulphone, a polyetherimide, a polyarylate, a polysulphone, a plasticized polyvinylchloride, an acrylonitrile butadiene styrene, a polystyrene, a polyetherimide, a metallocene-catalyzed polyethylene, a polyethylene, a polyurethane, a fluoroelastomer, copolymers thereof, or mixtures thereof.

Embodiment 11 provides the polymeric membrane of any one of Embodiments 1-10, wherein at least one of the first and the second thermoplastic elastomer layers independently comprises a hydrogenated styrene ethylene butylene styrene polymer, styrene-isoprene block copolymer, styrene ethylene propylene styrene polymer, or mixtures thereof.

Embodiment 12 provides the polymeric membrane of any one of Embodiments 1-11, wherein a thickness of at least one of the first and the second thermoplastic elastomer layers is independently in a range of from about 3 mils to about 200 mils.

Embodiment 13 provides the polymeric membrane of any one of Embodiments 1-12, wherein a thickness of at least one of the first and the second thermoplastic elastomer layers is independently in a range of from about 15 mils to about 160 mils.

Embodiment 14 provides the polymeric membrane of any one of Embodiments 1-13, wherein a filler component is independently at least about 30 wt % of at least one of the first and the second thermoplastic elastomer layers.

Embodiment 15 provides the polymeric membrane of any one of Embodiments 1-14, wherein a filler component is independently at least about 40 wt % of at least one of the first and the second thermoplastic elastomer layers.

Embodiment 16 provides the polymeric membrane of any one of Embodiments 1-15, wherein a filler component is independently at least about 60 wt % of at least one of the first and the second thermoplastic elastomer layers.

Embodiment 17 provides the polymeric membrane of any one of Embodiments 1-16, wherein at least one of the first and the second thermoplastic elastomer independently comprises about 30 wt % to about 80 wt % of a filler component.

Embodiment 18 provides the polymeric membrane of any one of Embodiments 1-17, wherein at least one of the first and the second thermoplastic elastomer independently comprises about 40 wt % to about 50 wt % of a filler component.

Embodiment 19 provides the polymeric membrane of any one of Embodiments 1-18, wherein the filler component comprises a particulate filler.

Embodiment 20 provides the polymeric membrane Embodiment 19, wherein the filler is an inorganic filler.

Embodiment 21 provides the polymeric membrane of any one of Embodiments 19 or 20, wherein the filler component comprises nepheline syenite, calcium carbonate, magnesium hydroxide, talc, alumina, zirconia, boehmite, amorphous silica, kaolinite, calcite, a clay, TiO₂, or mixtures thereof.

Embodiment 22 provides the polymeric membrane of any one of Embodiments 19-21, wherein a largest dimension of the filler is in a range of from about 5 μm to about 300 μm.

Embodiment 23 provides the polymeric membrane of any one of Embodiments 19 or 22, wherein a largest dimension of the filler is in a range of from about 40 μm to about 50 μm.

Embodiment 24 provides the polymeric membrane of any one of Embodiments 1-23, wherein at least one of the first and the second thermoplastic elastomer layers are substantially planar.

Embodiment 25 provides the polymeric membrane of any one of Embodiments 1-24, wherein at least one of the first and the second thermoplastic elastomer layers comprise a plurality of closed or open cells.

Embodiment 26 provides the polymeric membrane of any one of Embodiments 1-25, wherein at least one of the first and the second thermoplastic elastomer layers comprise a plurality of expandable microspheres.

Embodiment 27 provides the polymeric membrane of any one of Embodiments 25 or 26, wherein the one or more open or closed cells have diameter in a range of from about 1 μm to about 1000 μm.

Embodiment 28 provides the polymeric membrane of any one of Embodiments 25-27, wherein the one or more open or closed cells have diameter in a range of from about 30 μm to about 1000 μm.

Embodiment 29 provides the polymeric membrane of any one of Embodiments 26-28, wherein the one or more open or closed cells have diameter in a range of from about 5 μm to about 50 μm.

Embodiment 30 provides the polymeric membrane of any one of Embodiments 26-29, wherein a volume of an individual expandable microsphere in an expanded state is in a range of from about Embodiment 10 times to about 80 times larger than a volume of the expandable microsphere in an unexpanded state.

Embodiment 31 provides the polymeric membrane of any one of Embodiments 26-30, wherein a volume of an individual expandable microsphere in an expanded state is in a range of from about 30 times to about 50 times larger than a volume of the expandable microsphere in an unexpanded state.

Embodiment 32 provides the polymeric membrane of any one of Embodiments 26-31, wherein the plurality of the expandable microspheres are independently in a range of from about 0.5 wt % to about 20 wt % of at least one of the first thermoplastic elastomer and the second thermoplastic elastomer.

Embodiment 33 provides the polymeric membrane of any one of Embodiments 26-32, wherein the plurality of the expandable microspheres are independently in a range of from about 2 wt % to about 10 wt % of the thermoplastic elastomer of at least one of the first thermoplastic elastomer and the second thermoplastic elastomer.

Embodiment 34 provides the polymeric membrane of any one of Embodiments 1-33, wherein the membrane is free of a reinforcement.

Embodiment 35 provides the polymeric membrane of any one of Embodiments 1-34, wherein the membrane is free of a scrim.

Embodiment 36 provides the polymeric membrane of any one of Embodiments 1-33, wherein the membrane includes a reinforcement.

Embodiment 37 provides the polymeric membrane of any one of Embodiments 1-33 or 36, wherein the membrane includes a scrim.

Embodiment 38 provides the polymeric membrane of any one of Embodiments 1-37, wherein the first thermoplastic elastomer layer and the second thermoplastic elastomer layer are at least partially diffused into each other to form a monolithic membrane.

Embodiment 39 provides the polymeric membrane of any one of Embodiments 1-38, wherein the first thermoplastic elastomer layer comprises a larger amount by weight percent of filler component than the second thermoplastic elastomer layer.

Embodiment 40 provides the polymeric membrane of any one of Embodiments 1-39, wherein the first thermoplastic elastomer and the second thermoplastic elastomer layers comprise a plurality of closed cells and the closed cells of the first thermoplastic elastomer layer are a larger volume percent of the first thermoplastic elastomer layer than a volume percent of the closed cells of second thermoplastic elastomer layer.

Embodiment 41 provides the polymeric membrane of any one of Embodiments 1-40, wherein the membrane is free of asphalt.

Embodiment 42 provides the polymeric membrane of any one of Embodiments 1-41, wherein the membrane is free of polypropylene.

Embodiment 43 provides the polymeric membrane of any one of Embodiments 1-42, wherein

the first thermoplastic elastomer layer comprises:
a hydrogenated styrene ethylene butylene styrene polymer, and
about 40 wt % to about 50 wt % filler component; and

the second thermoplastic elastomer layer comprises:
a hydrogenated styrene ethylene butylene styrene polymer, and
less filler component by wt % than the first thermoplastic elastomer layer; and

the first thermoplastic elastomer layer and the second thermoplastic elastomer layer are at least partially diffused into each other to form a monolithic membrane.

Embodiment 44 provides the polymeric membrane of any one of Embodiments 1-43, further comprising a third thermoplastic elastomer layer in contact with the first thermoplastic elastomer layer such that the first thermoplastic elastomer layer is between the second thermoplastic elastomer layer and the third thermoplastic elastomer layer.

Embodiment 45 provides the polymeric membrane of Embodiment 44, wherein at least one of the first thermoplastic elastomer layer, the second thermoplastic elastomer layer, and the third thermoplastic elastomer layer are at least partially diffused into each other to form a monolithic membrane.

Embodiment 46 provides the polymeric membrane of any one of Embodiments 1-45, wherein the membrane is free of an adhesive disposed between any one of the first, second, and third thermoplastic elastomer layers.

Embodiment 47 provides the polymeric membrane of any one of Embodiments 1-46, wherein the first, second, and third thermoplastic elastomer layers directly contact one another.

Embodiment 48 provides the polymeric membrane of any one of Embodiments 1-46, further comprising a release liner removably attached to an external surface of the membrane.

Embodiment 49 provides the polymeric membrane of any one of Embodiments 1-48, wherein the polymeric membrane is a roofing membrane.

Embodiment 50 provides an assembly comprising:

the polymeric membrane of any one of Embodiments 1-49; and

a substrate;

wherein a first major surface of the polymeric membrane is adhered to the substrate.

Embodiment 51 provides the assembly of Embodiment 50, wherein the substrate is a roof, a water moisture barrier, a foam, a metal, asphalt, or a wood.

Embodiment 52 provides the assembly of Embodiment 51, wherein the roof is substantially planar.

Embodiment 53 provides the assembly of any one of Embodiments 50-52, wherein the assembly is free of an adhesive disposed between the roofing membrane and the substrate.

Embodiment 54 provides the assembly of any one of Embodiments 50-53, wherein a second major surface of the polymeric membrane opposite the first major surface is substantially free of covering.

Embodiment 55 provides the assembly of any one of Embodiments 50-54, further comprising a ballast layer disposed over at least a portion of a second major surface of the polymeric membrane opposite the first major surface.

Embodiment 56 provides the assembly of Embodiment 55, wherein the ballast layer comprises rocks.

Embodiment 57 provides the assembly of any one of Embodiments 50-56, further comprising a plurality of the polymeric membranes.

Embodiment 58 provides the assembly of Embodiment 57, wherein adjacent polymeric membranes are in contact along a minor surface joining respective first and second major surfaces.

Embodiment 59 provides the assembly of Embodiment 58, the materials in contact along the minor surface are at least partially diffused into each other to form a monolithic membrane.

Embodiment 60 provides a roof comprising the polymeric membrane of any one of

Embodiments 1-59.

Embodiment 61 provides a method of making the polymeric membrane of any one of Embodiments 1-60, the method comprising:

Combining a thermoplastic elastomer with at least one of a foaming agent and the filler component to form a mixture; and

extruding the thermoplastic elastomer to form the first thermoplastic elastomer.

Embodiment 62 provides the method of Embodiment 61, wherein the foaming agent comprises an expandable microsphere, an exothermic chemical blowing agent, an endothermic chemical blowing agent, a physical blowing agent, or mixtures thereof.

Embodiment 63 provides the method of Embodiment 62, wherein the exothermic chemical blowing agent comprises an azo compound, a diazo compound, a sulfonyl hydrazide, a sulfonyl semicarbazide, a tetrazole, a nitroso compound, an acyl sulfonyl hydrazide, a hydrazine, a thiatriazole, an azides, a sulfonyl azide, an oxalate, a thiatrizene dioxide, isotoic anhydride, ammonium nitrite, or mixtures thereof.

Embodiment 64 provides the method of any one of Embodiments 62 or 63, wherein the endothermic chemical blowing agent comprises an inorganic carbonate, a bicarbonate, a nitrate, a borohydride, citric acid, polycarbonic acid, or mixtures thereof.

Embodiment 65 provides the method of any one of Embodiments 62-64, wherein the physical blowing agent comprises a compressed gas, a liquid, a solid, or mixtures thereof.

Embodiment 66 provides the method of any one of Embodiments 62-65, wherein the physical blowing agent comprises carbon dioxide, nitrogen, argon, water, butane, 2,2-dimethylpropane, pentane, hexane, heptane, 1-pentene, 1-hexene, 1-heptene, benzene, toluene, a fluorinated hydrocarbon, methanol, ethanol, isopropanol, ethyl ether, isopropyl ketone, or mixtures thereof.

Embodiment 67 provides the method of any one of Embodiments 61-66, further comprising extruding a second thermoplastic elastomer and contacting the second thermoplastic elastomer with the first thermoplastic elastomer.

Embodiment 68 provides a method of forming the assembly of any one of Embodiments 50-59, the method comprising:

applying the polymeric membrane of any one of Embodiments 1-49 or formed according to the method of any one of Embodiments 61-67 to a substrate; and

heating the polymeric membrane.

Embodiment 69 provides the method of Embodiment 68, wherein the polymeric membrane is heated to a temperature of at least about 70° C.

Embodiment 70 provides the method of any one of Embodiments 68 or 69, wherein the polymeric membrane is heated to a temperature in a range of from about 70° C. to about 250° C.

Embodiment 71 provides the method of any one of Embodiments 68-70, wherein the polymeric membrane is heated to a temperature in a range of from about 90° C. to about 120° C.

Embodiment 72 provides the method of any one of Embodiments 68-71, wherein the polymeric membrane is not heated to a temperature above 250° C.

Embodiment 73 provides the method of any one of Embodiments 68-72, further comprising adhering the polymeric membrane to the substrate.

Embodiment 74 provides the method of any one of Embodiments 68-73, further comprising contacting the polymeric membrane with a second polymeric roofing membrane.

1. A polymeric membrane comprising:
a first thermoplastic elastomer layer, comprising a styrenic thermoplastic, wherein the first thermoplastic elastomer layer has a foam structure.

2. The polymeric membrane of claim 1 wherein the styrenic thermoplastic comprises ethylene and butadiene blocks.

3. The polymeric membrane of claim 2 wherein the styrenic thermoplastic is a styrene-ethylene-butadiene-styrene thermoplastic.

4. The polymeric membrane of claim 1, further comprising a second thermoplastic elastomer layer in contact with the first thermoplastic elastomer layer.

5. The polymeric membrane of claim 4, wherein at least one of the first and the second thermoplastic elastomer independently comprises a thermoplastic polymer having at least one glass transition temperature in a range of from about 30° C. to about 150° C.

6. The polymeric membrane of claim 4, wherein the second thermoplastic elastomer layers independently comprises an acrylate, a methacrylate, a poly(methyl methacrylate), a siloxane, a styrene-isoprene block copolymer, a styrene ethylene butylene styrene polymer, a hydrogenated styrene ethylene butylene styrene polymer, a polyamide-imide, a polyethersulphone, a polyetherimide, a polyarylate, a polysulphone, a polyvinylchloride, an acrylonitrile butadiene styrene, a polystyrene, a polyetherimide, a metallocene-catalyzed polyethylene, a polyethylene, a polyurethane, a fluoroelastomer, a polyolefin, an EPDM, a rubber, copolymers thereof, or mixtures thereof.

7. The polymeric membrane of claim 1 comprising a scrim on the first thermoplastic elastomer layer.

8. The polymeric membrane of claim 1 comprising a scrim embedded in the first thermoplastic elastomer layer.

9. (canceled)

10. (canceled)

11. The polymeric membrane of claim 1, wherein the first thermoplastic elastomer comprises about 30 wt % to about 80 wt % of a filler component.

12. (canceled)

13. The polymeric membrane of claim 11, wherein the filler component comprises nepheline syenite, calcium carbonate, magnesium hydroxide, talc, alumina, zirconia, boehmite, amorphous silica, kaolinite, calcite, a clay, fly ash, or mixtures thereof.

14. The polymeric membrane of claim 11, wherein a largest dimension of the filler is in a range of from about 0.005 μm to about 500 μm.

15. (canceled)

16. (canceled)

17. The polymeric membrane of claim 1, wherein the first thermoplastic elastomer layers comprise a plurality of gas filled cells or hollow particles.

18. The polymeric membrane of claim 4 wherein the second thermoplastic elastomer comprises a filler component.

19. The polymeric membrane of claim 1 wherein the foamed structure has an open cell structure.

20. The polymeric membrane of claim 1 wherein the foamed structure has a closed cell structure.

21. An assembly comprising:
the polymeric membrane of claim 1; and
a substrate;
wherein a first major surface of the polymeric membrane is adhered to the substrate.

22. A method of making a polymeric membrane, the method comprising:
combining a thermoplastic elastomer comprising a styrenic thermoplastic with a foaming agent to form a mixture; and
extruding the thermoplastic elastomer to form the first thermoplastic elastomer.

23. The method of claim 22, wherein the foaming agent comprises an expandable microsphere, an exothermic chemical blowing agent, an endothermic chemical blowing agent, a physical blowing agent, or mixtures thereof.

24. The method of claim 23, wherein
the exothermic chemical blowing agent comprises an azo compound, a diazo compound, a sulfonyl hydrazide, a tetrazole, a nitroso compound, an acyl sulfonyl hydrazide, a hydrazine, a thiatriazole, an azides, a sulfonyl azide, an oxalate, a thiatrizene dioxide, isotoic anhydride, ammonium nitrite, or mixtures thereof; and
the endothermic chemical blowing agent comprises an inorganic carbonate, a bicarbonate, a nitrate, a borohydride, citric acid, polycarbonic acid, or mixtures thereof.

25. (canceled)

26. The method of claim 22, further comprising extruding a second thermoplastic elastomer and contacting the second thermoplastic elastomer with the first thermoplastic elastomer.
